(19) United States
(12) Patent Application Publication
(10) Pub. No.: US 2010/0295973 A1
(43) Pub. Date: Nov. 25, 2010

(54) DETERMINATE AND INDETERMINATE OPTICAL SYSTEMS

(75) Inventors: Christopher Aubuchon, San Jose, CA (US); James Morris, Lake Wylie, SC (US); Gregory Kintz, Asheville, NC (US); James Carriere, Charlotte, NC (US); Michael R. Feldman, Huntersville, NC (US)

Correspondence Address: Turocy & Watson, LLP, 127 Public Square, 57th Floor, Key Tower, Cleveland, OH, 44114, US

(73) Assignee: TESSERA NORTH AMERICA, INC., Charlotte (NC)

(21) Appl. No.: 12/741,725

(22) PCT Filed: Nov. 4, 2008
(86) PCT No.: PCT/US2008/012528

§ 371 Date: Aug. 10, 2010

Related U.S. Application Data
(60) Provisional application No. 61/001,988, filed on Nov. 6, 2007.

(51) Int. Cl. H04N 5/217; G02B 13/20

(52) U.S. Cl. 348/241; 359/707; 348/E05.078

(57) ABSTRACT

An optical system (302) has a plurality of optical surfaces (304, 305, 306, 307, 308, 309) configured to provide blurred images of objects located within a selected range of object distances. At least two of the plurality of optical surfaces are configured to contribute to the blurring. An imaging system (300) includes a blurring optical system (302), a sensor (310) which receives light directed through the optical system, and an image processor (320) which selects one or more deblurring functions and applies the deblurring functions to provide a processed image. The processor may apply different deblurring functions to different sets of the raw data representing different portions of the field of view.

### CROSS-REFERENCE TO RELATED APPLICATION

This application claims the benefit of the filing date of U.S. Provisional Application No. 61/001,988 filed Nov. 6, 2007, the disclosure of which is incorporated herein by reference.

### BACKGROUND OF THE INVENTION

The present invention is directed to optical systems and, more particularly, to optical systems that are located at a fixed position within an imaging system and that provide a customized depth of field.

In a conventional digital imaging system, light received by an optical system consisting of one or more lenses is projected onto an image plane at which an image sensor is located. The received light may be, for example, light reflected off of or light emitted by one or more objects located at various distances from the lens. The image sensor detects the image directed onto the image plane and generates raw data that is processed by an image processor which produces a processed image that is available for storage or for viewing. In such conventional systems, however, only objects located within a small range of distances are focused onto the image plane for a given lens position, namely, for a given distance between the lens or lenses and the image plane. Objects located outside this range of object distances, which is known as the depth of field, may be directed onto the image plane but are not focused and appear blurred in the processed image. As a result, some objects in the processed image may appear in focus whereas other objects in the processed image appear out of focus depending on the distance of each object from the lens.

To focus objects located at other image distances using such conventional digital imaging systems, the lens must be moved within the imaging system to change the distance between the lens and the image plane. However, such movement also causes objects that previously appeared in focus to now appear out-of focus. Thus, only a portion of the objects in an image will appear in focus regardless of the lens position.

Recently, hand-held cellular telephones and various other devices have been introduced which incorporate a digital imaging system. Such devices typically require the optical surfaces to remain at a fixed position within the imaging system. It is not practical to include moving parts because of size and cost constraints, and thus their imaging systems have a fixed focal range.

To enable the imaging systems in such devices to provide acceptable processed images over a wider range of object distances, a known approach is to modify the imaging system by blurring the image directed onto the image plane. Because the optical properties of the blurring are known, the blurred image can be digitally processed to obtain an in focus processed image. The blurring and subsequent digital processing of the image allows for a wider range of object distances at which the processed image appears acceptably sharp, thereby extending the depth of field of the imaging system.

Such blurring is attained by incorporating a single blurring optical surface into an existing optical system that was originally intended to provide images having optimum image quality. Namely, the blurring optical surface is added to an optical system that was initially designed to provide the best possible focusing, i.e., provide optimal aberration control. For example, over a small range of distances, a diffraction limited optical system is such a system. Such optical systems that provide high quality focusing and aberration control are typically expensive to design and manufacture, an unnecessary expense given that the image that is directed onto the image plane is blurred. Moreover, such optical systems have an increased length.

### SUMMARY OF THE INVENTION

According to an aspect of the invention, an optical system has a plurality of optical surfaces configured to provide blurred images of objects located within a selected range of object distances. At least two of the plurality of optical surfaces are configured to contribute to the blurring.

Preferably, the optical surfaces are configured so that no subset of the plurality of optical surfaces may provide a focused image of the object. Stated another way, the optical surfaces desirably are configured so that simply removing one or more of the optical surfaces would not leave a focusing optical system. Desirably, no subset of the plurality of optical surfaces forms a diffraction limited optical system. At object distances located near a hyperfocal distance of the optical system, the blurring may widen a point spread function (PSF) of the optical system. At object distances located near each end of the selected range of object distances, the blurring may narrow a point spread function (PSF) of the optical system. Within the selected range of object, distances, a modulation transfer function (MTF) of the optical system may be greater than a predetermined value.

Each one of the plurality of optical surfaces may contribute to broadening a through-focus modulation transfer function curve of the optical system. A peak modulation transfer function (MTF) of the optical system may be reduced when any one of the plurality of optical surfaces is removed. At least one of the optical surfaces may be configured to contribute differently to the blurring in different regions of that optical surface, and may be configured so that its contribution to the blurring changes discontinuously across a boundary between any two of these regions.

According to another aspect of the invention, a blurring optical system has a plurality of optical surfaces configured to provide images of objects located within a selected range of object distances. The blurring optical system has a particular f-number, field of view, number of optical surfaces, and optical track length. The blurring optical system according to this aspect of the invention desirably is arranged so that the peak modulation transfer function (MTF) of the blurring optical system is at least 50% of the peak MTF of a conventional non-blurring optical system having the same f-number, field of view, number of surfaces, and optical track length. The f-number, field of view, number of surfaces, and optical track length of the blurring optical system typically are such that the peak MTF of the conventional system having the same f-number, field of view, number of surfaces, and optical track length is less than about 70% of an MTF of a diffraction limited optical system having that f-number and field of view.

In accordance with this aspect of the invention, the number of optical surfaces may be less than that of a diffraction limited optical system, and may be less than that of a conventional optical system having a peak MTF of at least 80% of that of the diffraction limited system. The selected range of object distances may define a depth of field of the optical system. Each one of the plurality of optical surfaces may contribute to broadening the MTF of the optical system. The peak MTF of the optical system may be reduced when any one of the number of optical surfaces is removed.

A further aspect of the invention provides an imaging system which includes a blurring optical system and an image sensor operable to capture light directed by said optical system and to generate raw data representing the directed light. The imaging system according to this aspect of the invention desirably includes an image processor operable to process a first set of the raw data representing at least a portion of a field of view of the optical system by applying a plurality of different first deblurring functions to the first set of the raw data to yield a plurality of first processed image portions. The image processor desirably is also operable to select one of the plurality of first processed image portions having the best image quality. Systems according to this aspect of the invention can provide an auto-focusing capability. In one arrangement, the first set of raw data includes all of the raw data to be incorporated into a finished image, and the image processor simply supplies the selected first processed image portion as the finished image.

In other arrangements, the first set of raw data represents a first portion of the field of view of the optical system. The image processor may be arranged to select the first deblurring function which yielded the selected first processed image portion and apply the selected first deblurring function to additional sets of the raw data representing additional portions of the field of view to yield additional processed image portions.

In another variant, each of the plurality of different first deblurring functions is associated with an object distance. The image processor is operable to select an object distance associated with the first deblurring function which yielded the selected first processed image portion, and to select a set of additional deblurring functions associated with the selected object distance from among a plurality of sets of additional deblurring functions. The image processor is arranged to apply the deblurring functions in the selected set of deblurring functions to additional sets of the raw data representing additional portions of the field of view to yield additional processed image portions. For at least some object distances, the PSF of the optical system may differ for different portions of the field of view, and at least one of the sets of deblurring functions may include a plurality of different deblurring functions, each associated with a different portion of the field of view.

In yet another variant, the first set of raw data again represents a first portion of the field of view of the optical system. In this variant, the image processor is operable to process one or more additional sets of the raw data representing one or more additional portions of the field of view by applying a plurality of different additional deblurring functions to each additional set of the raw data to yield a plurality of processed image portions for such additional set of the raw data. The image processor is arranged to select one of the plurality of processed image portions having the best image quality for such additional set of the raw data, the selection step for each set of the raw data being performed independently of the selection step for other sets of raw data.

Yet another aspect of the present invention provides an imaging system which includes a blurring optical system having a point spread function (PSF) which differs for different portions of a field of view. The system according to this aspect of the invention includes an image sensor operable to capture light directed by said optical system and to generate raw data representing the directed light; and further includes an image processor operable to process at least part of the raw data to yield a processed image. Desirably, the image processor according to this aspect of the invention is operable to apply different deblurring functions to different portions of the raw data representing different portions of the field of view.

Further aspects of the invention include image processing methods incorporating generation of raw data and processing of the raw data as discussed above with reference to the imaging systems.

The foregoing aspects, features and advantages of the present invention will be further appreciated when considered with reference to the following detailed description and accompanying drawings.

### BRIEF DESCRIPTION OF THE DRAWINGS

FIG. 1 is a block diagram illustrating an example of a known digital imaging system.

FIG. 2 is a graphical representation of through-focus modulation transfer function (TF-MTF) curves for various examples of optical systems.

FIG. 3 is a graphical representation of TF-MTF curves for further examples of optical systems.

FIG. 4 is a ray diagram illustrating examples of the imaging of objects at various image distances.

FIG. 5 is a block diagram illustrating an example of a digital imaging system in accordance with an embodiment of the invention.

FIGS. 6A-6C are diagrams illustrating point spread function (PSF) curves in corresponding regions of a field of view for various image distances according to an embodiment of the invention.

FIGS. 7A-7C are diagrams illustrating PSF curves in corresponding regions of a field of view for various image distances in accordance with another embodiment of the invention.

FIGS. 8A-8C are diagrams illustrating PSF curves in corresponding regions of a field of view for different image distances according to a still further embodiment of the invention.

FIGS. 9A and 9B illustrate examples of the manner in which the regions shown in FIGS. 6A-6C, 7A-7C, and 8A-8C may be arranged.

FIG. 10 is a diagram illustrating yet another embodiment of the invention.

### DETAILED DESCRIPTION

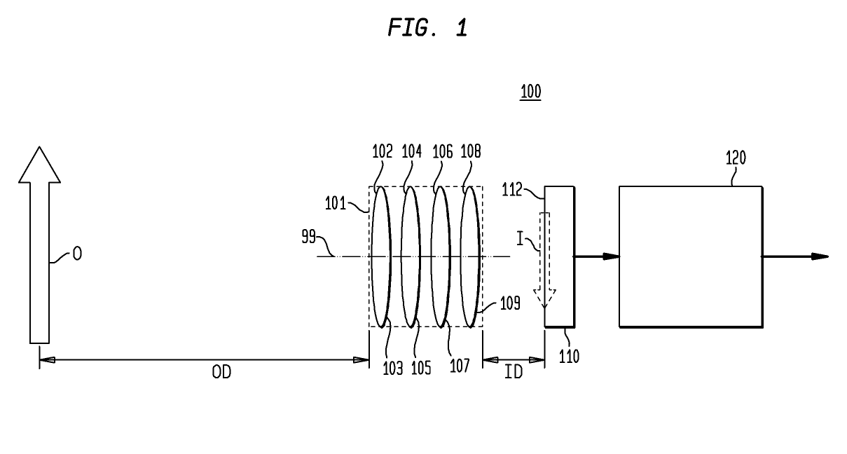

FIG. 1 is a block diagram depicting an example of a known digital imaging system 100. The digital imaging system 100 includes an optical system 101, an image sensor 110, and an image processor 120. The optical system 101 receives light that is reflected off of, or that is emitted by, an object O onto an image surface 112 of the image sensor 110. The optical system includes optical elements having surfaces 102 through 109 inclusive arranged along an optical axis 99. The object distance OD between the optical system and the object O, and the image distance ID between the optical system and the image I are distances along the optical axis 99. One of the optical surfaces 102 through 109 blurs an image directed onto the image surface 112 and the others provide for focusing of this image and for correction of chromatic or other aberrations. The blurring optical surface is typically located in the pupil plane of the optical system 101 though it is not restricted to that location. If the blurring optical surface is removed and replaced by a plane surface, the directed image is focused at the image surface 112. The optical elements of the optical system 101 are depicted as convex lenses solely for illustrative purposes. Actually, each optical element may be a refractive element or maybe a diffractive element which, for example, may include one or more drop-in masks, cubic phase masks, or circularly symmetric aspheric lenses.

The image sensor 110 receives light directed by the optical system 101 at the image surface 112, converts the captured light into raw data representing the captured light, and delivers the raw data to the image processor 120. The image sensor may be, for example, a charge coupled device (CCD) or a CMOS digital image sensor. The raw data typically is provided to the processor 120 in digital form.

The image processor 120 processes the raw data received from the image sensor 112 and generates a processed image that may be outputted to, for example, a memory device or a display device. As discussed further below, the image processor 120 may apply a mathematical function, referred to herein as a “deblurring” function, which sharpens the processed image.

If only focusing optical surfaces are present in the optical system 101 and the object O is located at a given object distance OD froth the optical system, a focused image I is present at a distance ID from the optical system. When the image surface 112 of the image sensor 110 is also located at distance ID from the optical system, the sharpest possible image is directed onto the image sensor 110. If the object O is moved nearer to or further from the optical system but the position of the image surface does not change (or, conversely, if the image surface is moved but the object O remains at the same distance from the optical system), the image quality of the projected image decreases. For a sufficiently small movement of the object O (or the image surface 112), the image quality of the image remains within an acceptable tolerance, namely, the image directed onto the image plane is of sufficient image quality for the image processor to provide an acceptable processed image. The range of object distances within which the image quality remains within this tolerance is referred to as the depth of field. Similarly, the range of image distances within which the image surface 112 may be moved while the image quality remains within tolerance is referred to as the depth of focus.

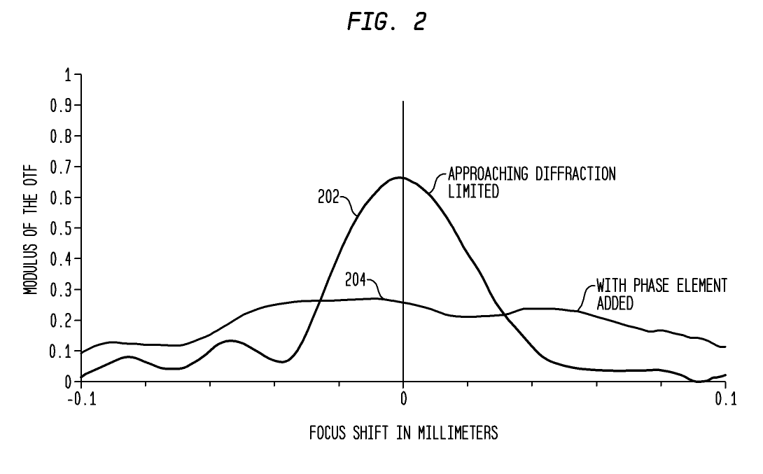

FIG. 2 illustrates a through-focus modulation transfer function (TF-MTF) curve 202 of a known optical system which includes only the focusing optical surfaces and which is designed to approach the diffraction limit. The TF-MTF curve depicts the modulus of the modulation transfer function (an indicator of the image quality) as a function of the distance between the image surface and the optical system. Unless otherwise stated, references to the “MTF” herein should be understood as referring to the modulus of the modulation transfer function.

For a given object distance, the TF-MTF curve is essentially bell shaped and peaks at a particular image distance; this image distance is the point denoted as zero focus shift. The MTF at zero focus shift is referred to herein as the “peak MTF.” The object distance used in measuring the TF-MTF curve typically is the hyperfocal distance F, namely, the nearest distance at which the optical system can be focused while the projected image of an object located at a substantially infinite distance remains acceptably sharp. The TF-MTF curve is shown for a given wavelength of light and will shift with a change in wavelength. For systems such as cameras intended to image visible light, the TF-MTF curve typically is taken at a wavelength of 589 nm, in the yellow region of the spectrum. Also, the MTF depends upon the spatial frequency at which the image is sampled. The MTF typically is calculated or measured at a sampling frequency of one-half of the Nyquist frequency to one quarter of the Nyquist frequency. Also, the MTF may vary with position within the image plane; the MTF typically referred to is the MTF on the optical axis. Though the TF-MTF curve is shown in FIG. 2 as a function of focus shift, i.e., as a function of image distance, an analogous curve may be generated as a function of object distance for a fixed image plane distance, i.e., for a sensor 110 located at a fixed distance from the optical system.

When the blurring optical surface is also included, such as by incorporating a blurring phase element, the range of image distances at, which the TF-MTF is above an acceptable value is increased, as shown by curve 204 in FIG. 2, though the image quality of the image at zero focus shift is reduced, as indicated by the lower peak MTF of curve 204. As an example, an MTF value of 0.1 or above typically can be considered acceptable where the raw data will be processed by an image processor to improve the image quality. When an MTF value of at least 0.1 is considered acceptable, a wider range of image distances have a MTF above this value in curve 204 than in curve 202 of FIG. 2. As a result, the addition of the blurring optical surface widens the depth of focus of the optical system 101.

By increasing the depth of focus, the corresponding depth of field is also widened. Stated another way, for objects located at object distances within this depth of field, the images that are directed onto the image surface 112 of the sensor are out of focus within an acceptable range, and have MTF within the acceptable range above 0.1. Such images are then converted into raw data by the image sensor 110 and delivered to the image processor 120. Because the blurring function is known, the image processor is able to generate processed images that are in focus using the raw data representing the blurred images.

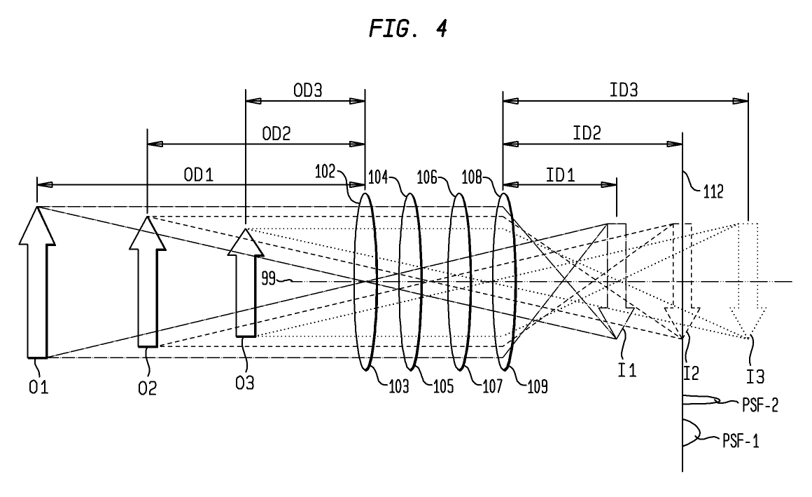

FIG. 4 also illustrates the effect of the addition of the blurring element. When only the optical surfaces that provide the focusing are present, only object O2 located at object distance OD2 is focused onto the image surface 112. In this condition, the rays emanating from a point on object O2 are focused to a small spot within image I2. Stated another way, the “point spread function” or “PSF,” representing the distribution of rays form a theoretical point on object O2, is a narrow distribution around a point within image I2. This is schematically shown by curve PSF-2 in FIG. 4. Object O1, which is located at object distance OD1, is further than object O2 from the optical system. Thus, the focusing optical surfaces form an image I1 at image distance ID1, which lies in front of the image plane 112 of the sensor. Object O3, which is located at object distance OD3, is nearer than object O2 to the optical system. The image surface thus forms an image I3 at image distance ID3 which would theoretically appear behind the image plane 112 of the sensor. Rays emanating from objects I1 and I3 are out of focus at image plane 112. For example, the rays from a point on object O1 are distributed over a relatively broad spot on image plane 112, as represented by a wide point spread function schematically shown by PSF-1 in FIG. 4.

When the blurring optical surface is added, the images I1, I2, I3 are each stretched in the direction along the optical axis 99 by varying the focal depth of the various rays emanating from each of the objects O1, O2, O3. The paths taken by the various rays emanating from object O2, for example, are changed by the blurring optical surface such that some rays are now focused in front of the image plane and some rays are now focused behind the image plane, rather than all the rays being focused at the image plane. The paths of the rays emanating from objects O1 and are each similarly changed by the blurring optical surface so that some of the rays emanating from each of these objects are now focused at the image plane. Namely, the addition of the blurring surface widens the point spread function (PSF) of the optical system at a nominal focus i.e., the PSF at object distance O2 corresponding to zero focus shift, and reduces the PSF for objects at the edges of a desired range of object distances. The objects O1, O2, and O3 are each directed onto the image plane 112 as blurred images which, after the corresponding raw data is processed by the image processor, are restored to the images I1, I2, and I3 shown in FIG. 4.

The known optical system 101 shown in FIGS. 1 and 4 consists of several optical surfaces that provide focusing and aberration correction together with an additional optical surface that provides blurring. Namely, if function F1 defines a point spread function (PSF) provided by the focusing and aberration correction optical surfaces and function F2 defines a PSF of the blurring optical surface, the PSF provided by the known optical system 101 is the convolution of the functions F1 and F2. Such optical systems are typically designed by adding the blurring optical surface to an existing design that was intended to provide optimal focusing, i.e., provide optimal aberration control, such as is attained by a diffraction limited optical system. Thus, the optical system 101 needlessly adds the expense of incorporating a diffraction limited optical system or other optimized focus optical system into a system that is to provide only blurred images. The optimized focus optical system also has an increased path length.

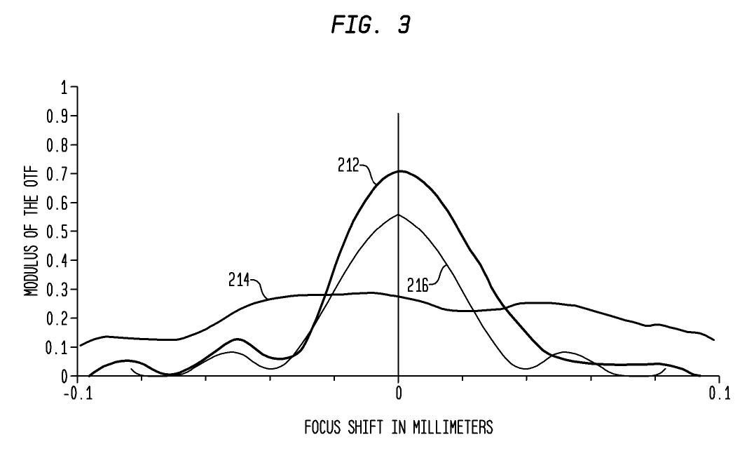

FIG. 3 illustrates a TF-MTF curve 216 of an optical system in which the optical surfaces are designed to substantially maximize the peak MTF for a pre-selected f-number, field of view, number of optical surfaces and track length. Such an optical system is referred to herein as a “conventional” or “non-blurring” optical system. A diffraction-limited optical system having the same f-number and field of view has an MTF as shown by curve 212, with an MTF modulus which reaches a high peak at zero focus shift but drops off rapidly with focus shift. Where the number of optical surfaces, track length or both are less than those of the diffraction-limited system, the peak MTF modulus of the conventional system, at zero focus shift, is considerably less than the peak MTF of the diffraction-limited system. This effect is particularly pronounced in systems such as those used in compact, inexpensive devices such as cameras incorporated in cellular telephones, personal digital assistants (“PDAs”) and other portable electronic devices; such systems are subject to severe space and cost constraints. The peak MTF of the conventional system made to meet such constraints typically is about 70% or less of the peak MTF of the diffraction-limited system, and may be about 50%-70% of the peak MTF of the diffraction-limited system. However, the MTF of the conventional system drops off less rapidly than the MTF of the diffraction-limited system with focus shift.

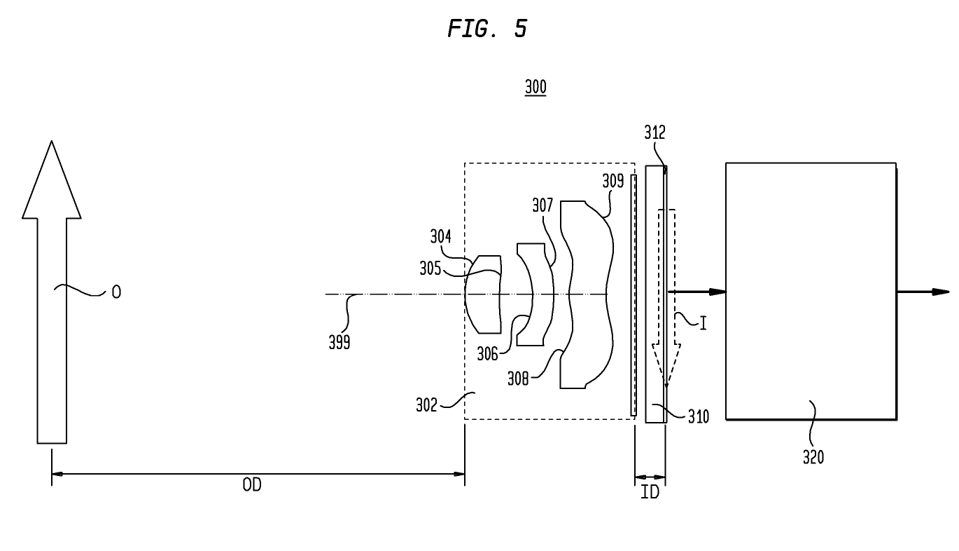

FIG. 5 illustrates an imaging system 300 in accordance with an embodiment of the invention in which the optical system 302 is designed from the start as an optical system that is to provide blurred images for objects located within a selected range of object distances. This optical system includes optical elements having surfaces 304 through 309 inclusive. The optical elements are arranged along an optical axis 399. For a given f-number, field of view, number of optical surfaces, and optical track length, the optical system 302 has a modulation transfer function (MTF) curve 214, shown in FIG. 3. Optical system 302 has a peak MTF that is at least about 50%, and desirably at least about 80%, of the peak MTF of the conventional system (MTF curve 216) with the same f-number, number of surfaces, and optical track length. However, the modulus of the MTF of system 302 shown in FIG. 5 (curve 214, FIG. 3) becomes greater than the modulus of the MTF of the conventional system (curve 216, FIG. 3) at large focus shifts. One measure of this effect is that the MTF of system 302 (curve 214) remains above a threshold value over a wider range of focus shift than the MTF of the conventional system (curve 216) in at least one direction from zero focus shift, and desirably in both directions. For example, where the threshold value is 0.1, curve 214 remains above the threshold from zero focus shift to about −0.1 mm focus shift, whereas curve 216 dips below the threshold at about −0.025 mm focus shift. Negative focus shift corresponds to smaller object distances. Curve 214 also remains above the 0.1 threshold for a wider range of focus shift in the positive direction, corresponding to greater object distance.

At least two of the optical surfaces in the optical system 302 contribute to the blurring, and no grouping of optical surfaces 304 through 309 selected from the optical system 302 forms a diffraction limited optical system or conventional non-blurring optical system. Rather, the two or more optical surfaces that contribute to the blurring each contribute to broadening the modulation transfer function (MTF) of the optical system, and when any one of the optical surfaces 304, . . . , 309 is removed, the directed image deteriorates because the peak MTF of the optical system is reduced. It should be noted that the shapes of the optical surfaces 304, . . . , 309 are for illustrative purposes only and merely indicate that the configurations of some or all of these optical surfaces differ from those shown in FIG. 1.

By dividing the blurring PSF among the optical elements and by designing the optical system from the start as an optical system that is to provide a blurred image, fewer optical elements are required when compared to the known optical systems which combine a conventional optical system designed to provide the best possible focusing with an additional blurring surface. As a result, the cost of the optical system can be reduced. Also, a much greater choice of configurations is available for each optical surface.

The imaging system 300 also includes an image sensor 310 having an image plane 312 that may function in a manner similar to that of the image sensor 110 of FIG. 1. An image processor 320 is also provided and processes the raw data received from the image sensor 310 by applying a deblurring function to attain a processed image.

The distribution of the blurring and focusing functions in optical system 302 can be described in terms of a function f1 which defines a PSF resulting from the focusing and function f2 which defines a PSF resulting from the blurring. The overall point spread function (PSF) of the optical system is a convolution of functions f1 and f2. Moreover, if function f_{A} defines an optical transmittance function of a particular one of the optical surfaces and function f_{B} defines an optical transmittance function of another one of the optical surfaces, the functions f_{A} and f_{B} each contribute to the function f2. Also, no subset including less than all of the optical surfaces provides f1.

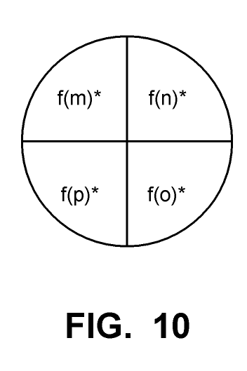

According to another embodiment of the invention, the contribution by a given optical surface to the blurring of an image is not uniform over the entire surface. Instead, the optical surface includes a plurality of regions each of which contributes differently to the blurring. FIG. 10 shows an example in which function f(m)* defines a first optical transmittance function in region m of a particular one of the optical surfaces, function f(n)* defines a second optical transmittance function in region n of the optical surface, function f(o)* defines a third optical transmittance function in region o of the optical surface, and function f(p)* defines a fourth optical transmittance function in region p of the optical surface. The different optical transmittance functions in each region create a discontinuity across the boundary between any two of the regions. The variation in contribution by each region allows for greater flexibility in the design of each optical surface.

Another aspect of the invention relates to the processing of the raw data a digital imaging system having a blurring optical system. The digital imaging system incorporates an optical system 302, sensor 310 and processor 320 generally as discussed above with reference to FIG. 5. The optical system 302 in this embodiment may include be a blurring optical system of the type discussed above with reference to FIG. 5 or another form of blurring optical system as, for example, a blurring optical system which incorporates separate focusing elements and blurring elements as discussed above with reference to FIG. 1.

The image processor 320 applies a function, referred to herein as a “deblurring function,” to the raw data from the sensor 310. As used in this disclosure, the term “deblurring function” refers to a function which at least partially reverses the effects of blurring in the raw data. The deblurring function thus produces a processed image which is appreciably sharper than the image represented by the raw data. Stated another way, the deblurring function at least partially reverses the effect of the point spread function of the optical system. Deblurring functions per se are known in the art. The deblurring function which yields the best image depends in part on the point spread function of the optical system.

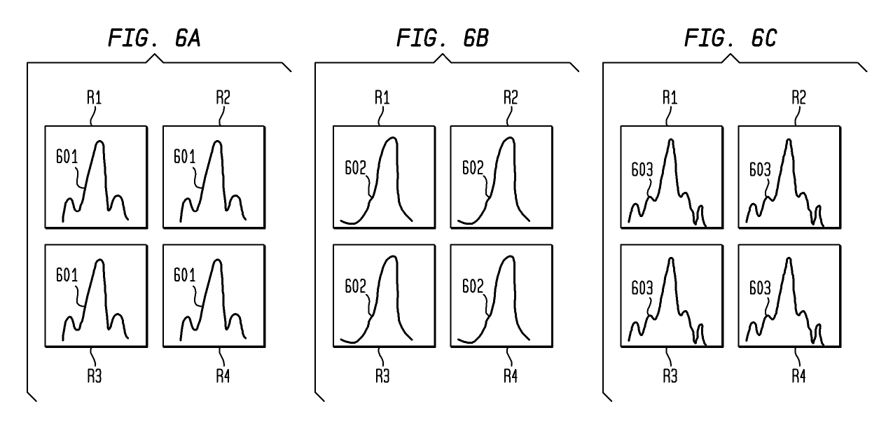

In one embodiment, the optical system is arranged such that the PSF is substantially constant across the field of view of the system but the PSF changes as a function of image distance or, equivalently, object distance. This is represented diagrammatically in FIGS. 6A-6C. As an example, curve 601 in FIG. 6A represents the PSF associated with a first range of object distances of 10 cm to 50 cm, curve 602 in FIG. 6B represents the PSF associated with a second range of object distances of 50 cm to 2 m, and curve 603 in FIG. 6C represents the PSF associated with a third range object distances greater than 2 m. In each of FIGS. 6A-6C, individual regions of the field of view are denoted by R1 through R4; for each range of object distances, the same PSF applies for all regions R1 through R4. The PSF typically will vary to some extent over the different regions and to some extent within each range of distances. However, within each range of object distances and over the entire field of view, the actual PSF is close enough to the PSF associated with that range of object distances that application of a deblurring function based on the PSF associated with that range of object distances to the raw data from sensor 310 will yield a useful processed image.

Processor 320 has access to stored deblurring functions associated with the various ranges of object distances. The deblurring functions may be stored in a conventional digital memory (not shown) which is incorporated in the processor itself or connected to the processor. The deblurring functions may be stored in any format. For example, each deblurring function may be stored in the form of a set of algorithmic instructions, coefficients or other information which can be used directly in processing of data from the sensor. Alternatively, each deblurring function may be stored as information from which information useful in processing the raw data can be derived. For example, a deblurring function associated with a particular range of object distances can be stored by storing the PSF associated with that range of object distances along with instructions for deriving the deblurring function from the PSF.

The stored deblurring function associated with a particular range of object distances can be calculated by calculating the PSF for an object distance within the range based on the design of the optical system, and determining the deblurring function based on the calculated PSF. Alternatively, the deblurring function for a particular range of object distances can be derived by measuring the PSF of an actual system at an image distance corresponding to an object distance within the range, and determining the deblurring function based on the measured PSF. In yet another arrangement, the deblurring function for a particular range of object distances can be derived by applying a variety of deblurring functions to raw data from the sensor of an actual system imaging an object at an object distance within the range, measuring one or more aspects of image quality such as image sharpness achieved by each deblurring function, and storing the particular deblurring function which yields the best image quality. Using measurements of PSF or image quality to derive each deblurring function compensates for manufacturing tolerances. In a mass-production process, such measurements can be performed for every system, or for a representative sample of the systems. Where systems are produced in batches, the measurements can be performed on one or a few samples in each batch, and the results applied to the remaining systems in the batch. For example, where the sensors are formed on semiconductor wafers and the optical elements are assembled to the sensors in a wafer-level process, the assemblies formed from each wafer may constitute a batch.

In operation, the when the image sensor of the imaging system captures an image directed by the optical system, the image processor 320 processes the raw data generated by the image sensor using each of the stored deblurring functions. The processor applies each of the stored deblurring functions separately to the raw data to obtain a plurality of processed images. At this stage, each processed image is in the form of digital data defining an image. The image processor tests each of these images for image quality. The step of testing for image quality may include testing for image sharpness. The processed image having the best image quality is selected. The selected processed image typically is stored or displayed, whereas the other processed images may be discarded. The processing carried out by the image processor allows the imaging system to provide the same effect as an auto-focus operation in a conventional camera without requiring movement of the optical surfaces. The imaging system does not require the moving parts that are otherwise needed to move the optical surfaces in known auto-focus systems. Moreover, the optical system need not provide a substantially constant PSF over a wide range of object distances. Stated another way, the ability of the processor to select from among a plurality of deblurring functions removes a constraint on the design of the optical system.

In another embodiment, the image processor 320 applies the various deblurring functions to a first set of the raw data which represents a first region of the field of view which is smaller than the entire field of view, such as region R1 (FIGS. 6A-6C) so as to yield a plurality of first processed image portions, each of which represents an image of region R1. The image processor tests each of the first processed image portions for image quality and selects the first processed image portion having the best image quality. By selecting the first processed image portion having the best image quality, the image processor selects the particular deblurring function which was used to produce the selected first processed image portion, and implicitly selects the range of object distances associated with that deblurring function. The image processor then processes additional raw data of additional regions R2-R4 using the selected deblurring function, and combines the resulting processed image portions with the selected first processed image portion to provide a complete image. As a result, the auto-focus operation is performed more quickly and using less processing capability.

In this embodiment, the deblurring function which is used to reconstruct the image is selected based on the object distance of the objects represented in the first region. For example, if the objects represented in the first region are foreground objects disposed in the first range of object distances (10 cm to 50 cm), the selected deblurring function will be appropriate for PSF 601. This deblurring function typically will not provide optimal deblurring for objects in other ranges of object distance. Thus, background objects disposed at large object distances may not be sharp in the processed image. This effect can provide aesthetically desirable results, similar to the effect of manually or automatically focusing a conventional lens having limited depth of field.

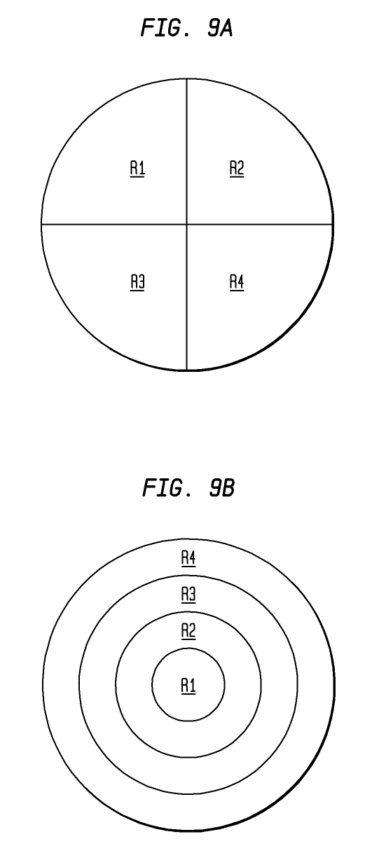

Regions R1-R4, though depicted as rectangular in FIGS. 6A-6C, may actually have any shape and/or arrangement. For example, as shown in FIG. 9A, regions R1, R2, R3, and R4 may be respective quadrants of a circular field of view. In another example, shown in FIG. 9B, regions R1, R2, R3, and R4 may be concentric regions in the field of view. Namely, region R1 may be a central region of the field of view, region R2 may be a ring-shaped region that surrounds region R1, region R3 may be a ring-shaped region that surrounds region R2, and region R4 may be a ring-shaped region that surrounds region R3. If central region R1 is used as the first region and the deblurring function is selected using raw data from the first region, the effect is similar to a “center-weighted” autofocusing function in a conventional camera. That is, the deblurring function will be selected so that objects near the center of the image will appear sharp in the processed image.

In a further variant, the first region may be a user-selectable region of the image. For example, in a system with an optical viewfinder or an electronic viewfinder which displays a crude image based on the raw data, the system may be provided with user controls which allow the user to move a cursor in the viewfinder and thus select a particular region of the image. This allows the user to select a region of the image depicting particularly important objects, and assures that the deblurring function will be selected to maximize the image quality of those objects.

In another variant, the image processor respectively selects a deblurring function for each region of the field of view independently of the selection for other fields of view. For the example shown in FIGS. 6A-6C, the raw data of first region R1 is processed in the same manner as discussed above, using each of the deblurring functions to yield a plurality of first processed image portions. Here again, each of the first processed image portions is tested for image quality, and the first processed image portion having the best image quality is selected. The raw data of second region R2 is processed using each of the deblurring functions to obtain three second processed image portions. The second image portions are each tested for image quality, and the second processed image portion having the most preferred image quality is selected for region R2. The selection of a second processed image portion, is independent of the selection of the first image portion. Stated another way, the deblurring function used to produce the selected second processed image portion is selected independently of the deblurring function used to produce the selected first processed image portion. Similar steps are also carried out for the raw data of region R3 and for the raw data of region R4. Because the processing and testing is carried out separately for each region, and because the deblurring function is selected independently for each region, differences in the distances of objects in different regions are corrected. As a result, the image processor extends the depth of focus and depth of field of the imaging system.

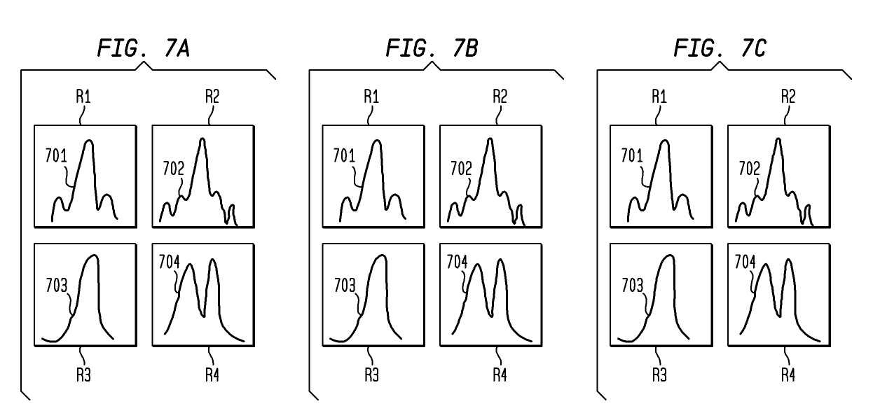

In another embodiment, a digital imaging system includes an optical system that is designed to provide a PSF that differs in different regions of the field of view, as described above, but which does not change substantially with object distance. For example, FIGS. 7A-7C illustrate respective PSF curves 701, 702, 703, and 704 in the four regions R1, R2, R3, and R4 of the field of view at three selected image distances and, equivalently, at three selected object distances. At any given image distance, the PSF curves in the four regions R1, R2, R3, and R4 differ from each other. However, the PSF curve 701 in the region R1 is substantially the same at all of these image distances, the PSF 702 of the region R2 is substantially the same at all of these image distances, and similarly for the regions R3 and R4 of the field of view. Stated another way, processing raw data from region R1 using a first deblurring function which compensates for PSF 701 will provide an acceptable processed image of objects in this region of the field of view at any of the three object distances. Likewise, a second deblurring function which compensates for PSF 702 will provide an acceptable image from raw data in region R2, and so on. In this embodiment, the image processor has access to a stored deblurring function associated with each region. The processor is programmed to simply apply the stored deblurring function associated with each region to raw data from that region, so as to yield processed image portions for the various regions, and to combine these processed image portions with one another. The deblurring function associated with each region can be calculated or based on measurements as discussed above.

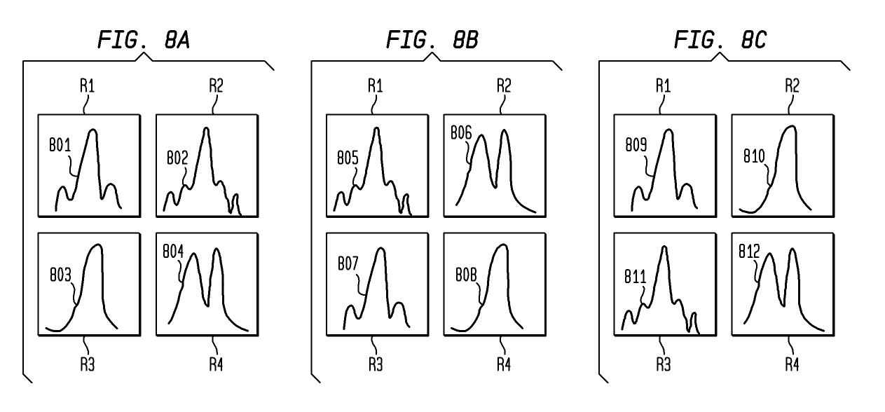

In a still further embodiment of the invention, a digital imaging system includes an optical system that provides a PSF that differs in different regions of the field of view and also varies as a function of image distance. For example, FIG. 8A shows PSF curves 801, 802, 803, and 804 that are respectively associated with the regions R1, R2, R3, and R4 at a first range of image distances or, equivalently, for a first range of object distances. FIG. 8B shows PSF curves 805, 806, 807, and 808 that are respectively associated with the regions R1, R2, R3, and R4 at a second range of object distances. FIG. 8C shows PSF curves 809, 810, 811, and 812 that are respectively associated with the regions R1, R2, R3, and R4 at a third range of object distances.

The image processor has access to stored deblurring functions appropriate for each of the PSF curves. A first set of deblurring functions is associated with the first range of image distances. The first set includes a first deblurring function which will compensate for PSF 801 associated with first region R1; a second deblurring function which will compensate for PSF 802 associated with second region R2, a third deblurring function appropriate to PSF 803 associated with third region R3, and a fourth deblurring function appropriate to PSF 804 for region R4. Likewise, a second set of deblurring functions, associated with the second range of object distances, includes first through fourth deblurring functions associated with regions R1-R4, respectively, the deblurring functions being appropriate to compensate for PSF functions 805, 806, 807 and 808, respectively. A third set of deblurring functions includes first through fourth deblurring functions appropriate to PSF functions 809-812.

When an image is captured by the image sensor of the imaging system, the image processor processes the first set of raw data from region R1 with each of the first deblurring functions associated with region R1, i.e., with the deblurring functions appropriate to PSFs 801, 805 and 809, to obtain three first processed image portions. Here again, the image processor tests the image quality of each first processed image portions and selects the first processed image portion having the best image quality. This selection implicitly selects an object distance and a set of deblurring functions. For example, if the first processed image portion obtained using a deblurring function appropriate to PSF 805 has the best image quality, the system has implicitly selected the second range of object distances (FIG. 8B) and the second set of deblurring functions. The processor then applies the other deblurring functions in the second set (the deblurring functions for PSFs 806, 807 and 808) to the sets of raw data from other regions R2, R3 and R4 to obtain additional processed image portions and form the final processed image. In this embodiment, the system effectively auto-focuses based on a single determination of object distance using raw data from first region R1.

The ability of the system to provide satisfactory image quality despite variation in PSF across the field of view and variation in PSF with object distance and image distance removes constraints from the design of the optical system. Here again, the stored deblurring functions can be derived by calculation from the design of the optical system, from measurements of PSF, or from measurements of image quality using different deblurring functions during manufacture of the system. In this embodiment, the calculations or measurements are performed separate for each region and for each range of object distance or image distance. Here again, where measurements are used to determine the stored deblurring functions, the processor will compensate for variations in manufacture of the system.

In another variant, the image processor selects a deblurring function for each region independently of the selection made for other portions. For example, the raw data of region R1 is processed with each of the deblurring functions associated with the first region R1 (the deblurring functions appropriate for PSF curves 801, 805, and 809) to provide a plurality of first processed image portions, and the first processed image portion having the most preferred image quality is selected for region R1. Similarly, the raw data for region R2 is processed with each of the deblurring functions associated with region R2 (the deblurring functions appropriate for PSF curves 802, 806, and 810) to provide a plurality of second processed image portions. The second processed image portion having the most preferred image quality is selected for region R2. The raw data for the third and fourth regions are treated similarly, using the deblurring functions associated with those regions.

The selection of the image portion having the most preferred image quality in each respective region of the field allows the image processor to correct for differences in the distance of objects in the different regions and thus extends the depth of field of the imaging system.

Although the features described above can be applied in a wide range of applications, they are particularly useful in systems of the type used in small, inexpensive digital cameras of the type found in cellular telephones, PDAs and other portable electronic devices. For example, the features described above can be implemented with an optical system having a track length of 1 cm or less, and more preferably 5 mm or less, and having 3 optical elements (6 optical surfaces) or fewer, such as those having only 2 optical elements or only 1 optical element. Also, the image processor typically is located within the same electronic device as the image sensor. In some applications, the optical sensor, image processor and image sensor may be provided as a module which can be mounted to a circuit panel or otherwise installed in a larger device. The image processor may perform functions other than deblurring as, for example, correction of geometric distortion.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An optical system having a plurality of optical surfaces configured to provide blurred images of objects located within a selected range of object distances, at least two of the plurality of optical surfaces being configured to contribute to the blurring.

2. An optical system according to claim 1, wherein no portion of the plurality of optical surfaces provides an image of the object having as great a modulation transfer function (MTF) as an image of the object provided by said optical system.

3. An optical system according to claim 1, wherein no portion of the plurality of optical surfaces comprises a diffraction limited optical system.

4. An optical system according to claim 1, wherein at object distances located near a hyperfocal distance of said optical system, the blurring provides said optical system with a point spread function (PSF) that is wider than a PSF of a conventional optical system.

5. An optical system according to claim 1, wherein at object distances located near each end of the selected range of object distances, the blurring provides said optical system with a point spread function (PSF) that is narrower than a PSF of a conventional optical system.

6. An optical system according to claim 1, wherein a modulation transfer function (MTF) of said optical system is less than that of a diffraction limited further optical system at a hyperfocal distance but is higher than that of the diffraction limited further optical system at an edge of the selected range of object distances of said optical system.

7. An optical system according to claim 1, wherein each one of the plurality of optical surfaces contributes to broadening a TF-MTF curve of said optical system.

8. An optical system according to claim 1, wherein at least one of the optical surfaces is configured to contribute differently to the blurring in different regions of that optical surface and is configured so that its contribution to blurring changes discontinuously across a boundary between any two of the different regions.

9. A blurring optical system having one or more optical elements defining a plurality of optical surfaces, the optical surfaces being configured to provide images of objects located within a selected range of object distances, the blurring optical system having a particular f-number, field of view, number of optical surfaces, and optical track length; a peak modulation transfer function (MTF) of the blurring optical system being at least 50% of a peak MTF of a conventional optical system having that f-number, number of surfaces, and optical track length, wherein the MTF of the blurring optical system is greater than the MTF of the conventional optical system at the edges of the selected range of object distances.

10. A blurring optical system as claimed in claim 9, wherein the f-number, field of view, number of optical surfaces and track length of the blurring optical system are such that the peak MTF of a conventional optical system having that f-number, field of view, number of optical surfaces and track length is less than about 70% of the peak MTF of a diffraction limited optical system having that f-number and field of view.

11. A blurring optical system according to claim 10, wherein the number of optical surfaces is less than that of a conventional optical system having the same f-number and field of view as said blurring optical system and having a peak MTF of at least 80% of that of the diffraction limited system.

12. A blurring optical system according to claim 11, wherein the MTF is measured on-axis.

13. A blurring optical system according to claim 11, wherein the MTF is measured at a spatial frequency in a range of from one-half of the Nyquist frequency (Nyquist/2) to one-quarter of the Nyquist frequency (Nyquist/4).

14. A blurring optical system according to claim 9, wherein the selected range of object distances corresponds to a depth of field that is greater than a depth of field of the optical system having the preferred MTF.

15. A blurring optical system according to claim 9, wherein each one of the plurality of optical surfaces contributes to broadening the MTF of said optical system.

16. A blurring optical system according to claim 9, wherein the peak MTF of said optical system is reduced when any one of the plurality of optical surfaces is removed.

17. An imaging system, comprising:
a blurring optical system;
an image sensor operable to capture light directed by said optical system and to generate raw data representing the directed light; and
an image processor operable to
(i) process a first set of the raw data representing at least a portion of a field of view of the optical system by applying a plurality of different first deblurring functions to the set of the raw data to yield a plurality of first processed image portions; and
(ii) select one of the plurality of first processed image portions having the best image quality.

18. An imaging system as claimed in claim 17 wherein the first set of raw data represents a first portion of the field of view of the optical system, and wherein the image processor is operable to select the first deblurring function which yielded the selected first processed image portion and apply the selected first deblurring function to additional sets of the raw data representing additional portions of the field of view to yield additional processed image portions.

19. An imaging system as claimed in claim 17 wherein the first set of raw data represents a first portion of the field of view of the optical system, each of the plurality of different first deblurring functions is associated with an object distance, and the image processor is operable to
(iii) select an object distance associated with the first deblurring function which yielded the selected first processed image portion;
(iv) select a set of additional deblurring functions associated with the selected object distance from among a plurality of sets of additional deblurring functions, each such set being associated with a different object distance; and
(v) apply the deblurring functions in the selected set to additional sets of the raw data representing additional portions of the field of view to yield additional processed image portions.

20. An imaging system as claimed in claim 19 wherein, for at least some object distances, the PSF of the optical system differs for different portions of a field of view, and wherein at least one of the sets of deblurring functions includes a plurality of different deblurring functions, each associated with a different portion of the field of view.

21. An imaging system as claimed in claim 17 wherein the first set of raw data represents a first portion of the field of view of the optical system, and wherein the image processor is operable to process one or more additional sets of the raw data representing one or more additional portions of the field of view by:
(iii) applying a plurality of different additional deblurring functions to each additional set of the raw data to yield a plurality of processed image portions for such additional set of the raw data; and
(iv) selecting one of the plurality of processed image portions having the best image quality for such additional set of the raw data, the selection step for each set of the raw data being performed independently of the selection step for other sets of raw data.

22. An imaging system, comprising:
a blurring optical system having a point spread function (PSF) which differs for different portions of a field of view;
an image sensor operable to capture light directed by said optical system and to generate raw data representing the directed light; and
an image processor operable to process at least part of the raw data to yield a processed image by applying different deblurring functions to different portions of the raw data representing different portions of the field of view.

23. A method of imaging comprising:
directing light from an object to be imaged through a blurring optical system to an image sensor;
capturing light directed by said optical system and generating raw data representing the directed light; and
processing a first set of the raw data representing at least a portion of a field of view of the optical system by applying a plurality of different first deblurring functions to the set of the raw data to yield a plurality of first processed image portions; and
selecting at least one of the plurality of first processed image portions having the best image quality.

24. A method as claimed in claim 23 wherein the first set of raw data represents a first portion of the field of view of the optical system, the method further comprising the step applying the first deblurring function which yielded the selected first processed image portion to additional sets of the raw data representing additional portions of the field of view to yield additional processed image portions.

25. An method as claimed in claim 23 wherein the first set of raw data represents a first portion of the field of view of the optical system and wherein each of the plurality of different first deblurring functions is associated with an object distance, further comprising the steps of:
selecting an object distance associated with the first deblurring function which yielded the selected first processed image portion;
selecting a set of additional deblurring functions associated with the selected object distance from among a plurality of sets of additional deblurring functions, each such set being associated with a different object distance; and
applying the deblurring functions in the selected set to additional sets of the raw data representing one or more additional portions of the field of view to yield one or more additional processed image portions.

26. A method as claimed in claim 25 wherein, for at least some object distances, the PSF of the optical system differs for different portions of a field of view, and wherein at least one of the sets of deblurring functions includes a plurality of different deblurring functions, each associated with a different portion of the field of view.

27. A method as claimed in claim 23 wherein the first set of raw data represents a first portion of the field of view of the optical system, the method further comprising the step of processing one or more additional sets of the raw data representing additional portions of the field of view by:
applying a plurality of different deblurring functions to each additional set of the raw data to yield a plurality of processed image portions for that additional set of raw data; and
selecting one of the plurality of processed image portions having the best image quality for that set of the raw data, the selection step for each set of the raw data being performed independently of the selection step for other sets of raw data.

28. A method of imaging comprising:
directing light from an object to be imaged through a blurring optical system to an image sensor;
capturing light directed by said optical system and generating raw data representing the directed light; and
processing at least part of the raw data to yield a processed image by applying different deblurring functions to different portions of the raw data representing different portions of a field of view.
